(19) United States
(12) Patent Application Publication
(10) Pub. No.: US 2005/0085998 A1
(43) Pub. Date: Apr. 21, 2005

(54) Provision of route-specific information

(75) Inventors: Werner M. Bless, Pfaffikon (CH); Urs Campbell, Ruti (CH); Franz Wolf, Rapperswil (CH)

Correspondence Address: DAVID LEWIS, 1605 THE ALAMEDA, SUITE 204, SAN JOSE, CA, 95126, US

(73) Assignee: Werner M. Bless

(21) Appl. No.: 11/006,303

(22) Filed: Dec. 6, 2004

Related U.S. Application Data
(63) Continuation-in-part of application No. PCT/EP03/05756, filed on Jun. 2, 2003.

(30) Foreign Application Priority Data
Jun. 2, 2002 (DE) 102 25 185.1

(51) Int. Cl. G01C 21/34

(52) U.S. Cl. 701/209; 340/995.19

(57) ABSTRACT

In a method for providing route-specific information in a vehicle, the present location of the vehicle is determined in the vehicle. A plurality of information data is received in the vehicle that in each case associate at least one route situation with locations or location areas. The plurality of information data is related in each case to the determined location of the vehicle, and there are determined the information data that comply with predefined association criteria. A device, a vehicle and a traffic information system comprise corresponding features. An embodiment of the invention improves and extends the technical possibilities of informing a vehicle driver about route situations.

### CROSS-REFERENCE TO RELATED APPLICATIONS

The present application claims priority benefit from PCT Application, PCT/EP03/05756, filed Jun. 2, 2003, now International Publication Number WO 105106, which in turn claims priority benefit of German Patent Application Number 102 25 185.1, filed Jun. 6, 2002, which are both hereby incorporated herein by reference.

### BACKGROUND OF THE INVENTION

1. Field of the Invention

The invention relates to a device and a method for providing route-specific information, the device being designed for employment in a vehicle, especially a motor vehicle. An embodiment of the invention further relates to a vehicle with such a device, as well as a traffic information system that makes use of the method.

2. Description of the Related Art

Route-specific information is traditionally made available to a vehicle driver via radio, especially traffic information broadcasts. This information consists, above all, of traffic jam and accident warnings. The radio station receives information about traffic jams and accidents, for example, from helicopters that overfly the roads. It is also known that persons involved in a traffic jam report the situation by telephone. Some radio stations also inform listeners about traffic or speed controls carried out by the police that traffic participants report via cellular telephones. It is also known for such information to be transmitted by means of pagers and SMS to traffic participants.

### SUMMARY OF SOME EMBODIMENTS OF THE INVENTION

An embodiment of the invention enlarges and improves the possibilities of informing a vehicle driver about road traffic situations.

An embodiment, of the present invention provides a device for providing route-specific information and intended for operation in a vehicle, with a location determination device for determining the present location of the vehicle, a reception device that is equipped for receiving a plurality of information data, where the information data associate locations or location areas in each case with at least one route situation, a processing unit that relates the plurality of information data with the determined location of the vehicle and determines the particular information data that comply with predefined relationship criteria, an output device that, reacting to a determination of information data by the processing device, emits at least one signal, at least one input device for entering a route situation, the input device being a keyboard with several keys, each key corresponding to one of a plurality of different route situations, and a sending device for sending out reporting data, where the reporting data are formed by the processing unit in reaction to a signal of the input device signaling that a key has been operated, wherein the reporting data specify at least one vehicle location determined by the location determination device and the route situation indicated by the corresponding key on the keyboard.

An embodiment of the present invention further provides a traffic information system with at least one system processing unit that is equipped for receiving reporting data from at least one first device for providing route-specific information, converting the reporting data into information data, passing the information data for transmission to a plurality of devices for providing route-specific information, each device for providing route-specific information operating in a vehicle and comprising: a location determination device for determining the present location of the vehicle, a reception device that is equipped for receiving a plurality of information data, where the information data associate locations or location areas in each case with at least one route situation, a processing unit that relates the plurality of information data with the determined location of the vehicle and determines the particular information data that comply with predefined relationship criteria, an output device that, reacting to a determination of information data by the processing device, emits at least one signal, at least one input device for entering a route situation, the input device being a keyboard with several keys, each key corresponding to one of a plurality of different route situations, and a sending device for sending out reporting data, where the reporting data are formed by the processing unit in reaction to a signal of the input device signaling that a key has been operated, wherein the reporting data specify at least one vehicle location determined by the location determination device and the route situation indicated by the corresponding key on the keyboard.

Another embodiment of the invention provides a method for providing route-specific information in a vehicle, in which: a plurality of information data is received in the vehicle that in each case associate at least one route situation with locations or location areas, the present location of the vehicle is determined in the vehicle, the plurality of information data is related in each case to the determined location of the vehicle and there are determined the information data that comply with predefined association criteria, and at least one signal is emitted in reaction to a determination of information data that comply with the predefined association criteria, wherein the information data originate at least partly from at least one central station that, in its turn, receives reporting data from participating vehicles, the reporting data of a participating vehicle specifying at least one location of the participating vehicle and a route situation that has been manually indicated by a driver of the participating vehicle.

The dependent claims define yet other embodiments of the invention.

The system in accordance with one embodiment of the invention has the advantage that a multitude of information data can be transmitted to each vehicle, though a signal is emitted only when the data in question is relevant, i.e. when the vehicle happens to be in the vicinity of a location or location area for which information about a route situation (traffic jam, speed control, accident site, . . . ) is actually available.

In an embodiment, the location of the vehicle may optionally be determined by means of a GPS receiver, so that components of a traditional navigation system or an entire such navigation system can be employed. The signal emitted by the device in accordance with an embodiment of the invention may be acoustic or optical or can exert a direct influence on the vehicle.

In one embodiment, the vehicle driver will be warned when he finds himself in the vicinity of the location or location area for which relevant information data are available. To this end a reporting distance from the location and/or the limits of the location area may be defined. The reporting distance may either be named in the information data or be firmly defined in connection with the given route situation. A location area may be defined, for example, by stating at least a center point and at least a radius, by specifying the corners of a polygon or by markings on the roads in the memory of a navigation system. When calculating the reporting distance, account may also be taken of the actual weather situation and the actual traffic speed. When a complete navigation system is used, the reporting distance may also be defined as a function of the road in question.

The information data may also contain time information that specifies the validity duration or the expiration time or the time of the latest report about the route situation. In an embodiment, the information data will be retained in a memory of the device and continuously compared with the determined location of the vehicle until such time as the validity duration has expired. The information data may also contain additional data, for example a reliability specification. Alternatively, an evaluation of the information data in the sense of a weighting may also be performed in the individual vehicles.

For obtaining the information data, provision is made for vehicle drivers to report relevant route situations that they note. To this end, an embodiment of the device is provided with an input device by means of which information concerning the particular route situation can be entered. This is then combined with the information determined by the location determination device to form appropriate reporting data. In an embodiment, the reporting data are sent to a central station (possibly via a receiver station of a mobile radio network), where they are processed and in various embodiments are also passed directly to other vehicles without any processing of the respective contents of the reporting data.

The route situation may be entered by the vehicle driver either mechanically (by means of one or more keys) or acoustically (by means of a speech recognition function). Alternatively or additionally, the input device may optionally also comprise a sensor for determining a vehicle state or a travel state parameter.

Other embodiments of the vehicle, the traffic information system, and the method are further described below with features that correspond to the characteristics mentioned above and/or in the dependent claims relating to the device.

### BRIEF DESCRIPTION OF THE DRAWINGS

Several alternative embodiments will now be described with the help of the schematic drawings, of which:

FIG. 1 shows a device for making available route-specific information that can be built into a vehicle, and

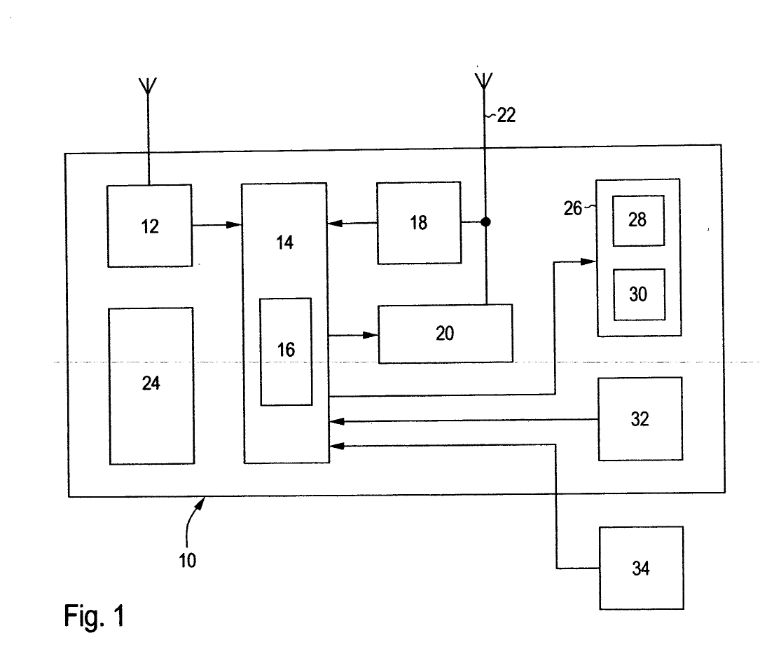

FIG. 2 shows a traffic information system in an embodiment of the invention.

### DETAILED DESCRIPTION OF EXEMPLARY EMBODIMENTS

In the sample embodiment here described, a device 10 in accordance with an embodiment of the invention for providing route-specific information may comprise a pager as reception device 12 for receiving information, a processor unit having access to a memory 16 as processing device 14 for the information data, a GPS receiver as location determination device 18 and a mobile telephone as sending device 20 for the broadcasting of the produced reporting data. The memory 16, for example, may have space for 1000 or more information data packages.

In the present sample embodiment the reception device 12 designed as a pager is a radio receiver that processes a radio signal with encoded data. The data contain a sequence of information data that are directed in the same way to all devices 10. In the present embodiment there is thus no individual addressing, which considerably reduces the technical and administrative cost. Other transmission technologies may be utilized in alternative embodiments, for example, via a mobile telephone network, a radio data system, a traffic message channel, a public access mobile radio or digital audio broadcasting.

The location determination device 18 in the present embodiment is a known continuously active receiver for the global positioning system as used, for example, in navigation systems. The sending device 20 utilizes a customary mobile radio system for broadcasting data, an antenna 22 being such as to be capable of being used by both the location determination device 18 and the sending device 20. The mobile radio system may be a GSM, GPRS or UMTS network. The named components are powered by an energy supply unit 24 connected with the power supply network aboard the vehicle. The energy supply unit 24 may be provided with a battery of its own, so that the device 10 can either be operated completely independently of the power supply network aboard the vehicle or, at least, continues to work for a certain period of time even without the onboard voltage.

In the present embodiment the output device 26 is provided with an optical indicator 28 (display or flashing light) and a loudspeaker 30 for emitting a warning sound and/or a spoken warning message. A warning message is emitted when the processing device 14 deems the information data contained in the memory 16 to be relevant after having compared them with the location data in accordance with predetermined relationship criteria (location in the vicinity of an area for which a certain route situation has been reported). This will be explained in greater detail further on.

In order to trigger the production of reporting data, the device 10 is provided with an input device 32 that in the present embodiment is designed as a keyboard with several keys. For example, there could be one key each for traffic jams, fog, dangerous road conditions such as ice, traffic accidents, traffic controls and other situations that call for greater attention by the vehicle driver. The production of reporting data may also be triggered automatically by means of a sensor 34 when, for example, the tire pressure drops or the brakes are fully applied or the flashing warning lights of the vehicle are switched on. The trigger signal causes the processing device 14 to produce the reporting data that the sending device 20 will transmit as a mobile radio message to a station of the appropriate mobile radio system, from which it will be passed on to a central station. Following a number of processing and verification steps at the central station, the appropriate information data corresponding to the reporting data are transmitted to other participating vehicles.

When in operation, the reception device 12 of the device 10 continuously receives information data that associate coordinates for various locations or location areas (for example, coordinates of the circumferential points of areas or the central point and radius of a circular area) with a given route situation. The information data are stored in the memory 16 and are there regularly updated, inasmuch as the data are regularly checked by the processing device 14 and data that are no longer relevant are deleted.

To determine whether information data should be deleted, they may be associated with an expiration time or a validity duration. Further, the validity may also depend on the route situation, so that, for example, information data for permanent danger points will be deemed relevant for longer than information data for temporary obstacles. For example, the validity duration of a traffic jam report may amount to ten minutes, in case of weather danger thirty minutes, and ten minutes in case of a broken down vehicle or an accident. Information data containing an instruction for deleting the previously stored data may also be provided, in that case the information packages may optionally be identified by means of an identifier contained in them.

The information data may also contain additional information, such as the times at which something was reported or a statement as to the number of times a route situation was reported. In alternative embodiments the additional information also consists of statements about the intensity of the arriving reports and/or the actuality and/or a vector or a direction relating to moving obstacles. The additional information may also assure that the processing unit will not emit a signal for vehicle drivers, because, for example, the time information suggests that it is highly probable that the route situation has changed.

At regular intervals the processing unit 14 receives location data from the location determination device 18 that specify the present position of the vehicle. These location data are compared in accordance with predetermined relationship criteria with the information data contained on the memory 16. These criteria can be rendered very simple by defining for certain route situations a fixed distance from the location and/or the location area specified in the information data. When the vehicle enters the distance range, a signal is emitted to the display 28 and/or the loudspeaker 30, thereby forewarning the vehicle driver. For example, in case of a traffic jam or some meteorological danger the warning distance may amount to between 2 and 5 km, in case of a broken down vehicle to between 100 and 500 m, and between 1 and 2 km in case of an accident. Multiple warning distances may also be envisaged, so that the vehicle driver will receive warning messages at staggered space intervals.

When the vehicle driver presses a key of the input device 32 and thereby indicates a present route situation, an appropriate signal is passed on to the processing device 14. The processing device 14 then asks the location determination device 18 for the present location of the vehicle and, if necessary, a clock will also be asked for the time. These values are used to form the reporting data that are transmitted to a central station via the sending device 20. Alternatively or additionally, the sending of reporting data about a route situation may also be triggered by the sensor 34. In the present sample embodiment the typical reporting data always contain two to four data components, namely the route situation to be reported, the present vehicle location and, whenever appropriate, a statement about the reporting participant and/or the present clock time.

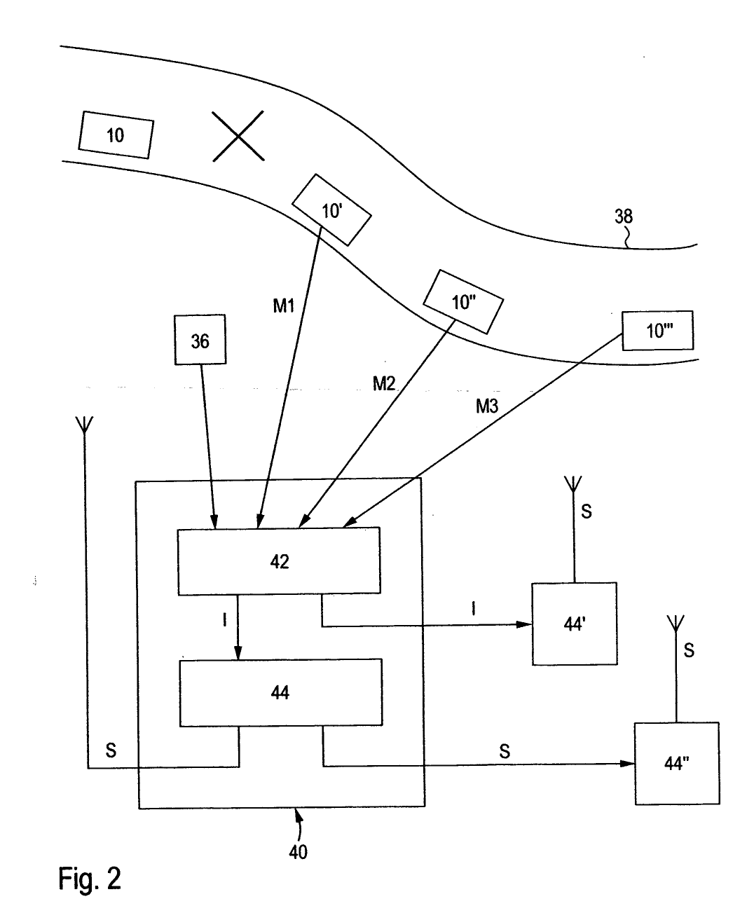

FIG. 2 shows how the reporting data M sent out by the vehicles are processed at a central station. A route situation to be reported about road 38, an accident site for example, is indicated by an “X” in FIG. 2. By way of example, the figure moreover shows four vehicles that are equipped with a device 10, 10′, 10″, 10′″ in accordance with an embodiment of the invention. The vehicle with the device 10 approaches the accident site. The vehicle driver notes the accident and gets ready to operate the appropriate key of the input device 32 as soon as the vehicle reaches the accident site. In the vehicles with the devices 10′, 10″ and 10′″, which have already passed the accident site, the production of the reporting data was triggered in each case on actually passing the accident site.

Reacting to the depression of the key by the various drivers, the devices 10′, 10″, 10′″ have produced reporting data M1, M2, M3. These reporting data M1, M2, M3 are then transmitted to the central station 40. The actual transmission process is less time-critical and may take place, for example, only 30 seconds after passing the accident site; the reporting data M1, M2, M3 should however contain as far as possible the precise location coordinates of each vehicle at the particular time when the reporting process was triggered. These location coordinates correspond to the position of the accident site.

In some embodiments provision has also been made for including other and temporally earlier location coordinates in the reporting data M1, M2, M3. In this manner both the route and the speed of the reporting vehicle can be transmitted. For example, when the location determination device 18 determines a location once every second and transmits it to the processing device 14, it is possible, for example, to record in each case the last five or ten locations prior to operating the reporting key in the reporting data M1, M2, M3. These locations can also be sent with the information data I to the other participating vehicles and will thus in each case constitute the center point of a (pre-)warning area with a relatively small radius. In this way the form and the extent of the effective warning area can be matched to the particular road pattern and the average speeds at which the vehicles proceed there at a small effort.

In the example of FIG. 2 the central station 40 thus receives at brief time intervals reporting data M1, M2, M3 within each case similar location data as position of the danger site to be reported. The reporting data M1, M2, M3 are received at the central station 40 and thence passed on to a processing unit 42. There the data are compared with each other in order to ascertain whether the existence of a relevant route situation can be concluded with sufficient reliability.

In the present sample embodiment such a sufficient reliability is assumed only when at least two vehicles report route situations that agree as regards both location and type within a brief space of time. But it is also possible to employ other evaluation criteria that take account, for example, of the type of route situation or the identity and previous reliability of the reporting participant. Further, it can be arranged for a danger situation to be considered as no longer existing when it has no longer been reported for a certain period of time. Appropriate information data I indicating the end of the danger situation can then be sent out.

In alternative embodiments the central station 40 employs further information for the production of the information data 1, including, for example, data from maps or geo-cartographic data banks or reports received as voice messages by a call center, or reports of the police or other parties. Arrangements may also be made for regularly sending out a certain basic volume of information data I that draw attention, for example, to known danger points of fixed location. Stations 36 in fixed location may also be provided to transmit reporting data to the central station 40.

Such a fixed station 36 may, for example, be an automatic sensor that monitors the road condition or also a reporting station that is activated, for example, when a school closes and will then report the school exit area as a danger source for the next few minutes.

When during the evaluation of the incoming reporting data M or for some other reason the processing unit 42 recognizes an event to be reported to the other participants, appropriate information data I are generated and sent out by a sending unit 44 as sending signal S. Where appropriate, the information data I and/or the sending signal S can also be passed on to other sending units 44′, 44″, thereby assuring adequate regional coverage. As already mentioned, the information data I encoded into the sending signal S will be received in the same manner by all the participating vehicles and evaluated by them; what takes place is thus a broadcast operation and not a targeted addressing of individual vehicles. This does not exclude that only such information data I are passed on for broadcasting by the sending stations 44, 44′, 44″ as refer to the region in which each particular sending unit 44, 44′, 44″ is situated.

The transmitted information data I contain an information item about the route situation and at least one other in the form of X-Y coordinates or in the form of the limits of a location area (for example, several coordinates as corners of a polygon, markings on roads that are stored in a navigation system, . . . ). Information may also be provided about the number and/or the reliability of the reporting participants and/or the actuality of the reports. A direction indication may also be included when, for example, a traffic jam moves in a particular direction. Lastly, the information data I may contain a time duration that specifies for how long the processing unit 14 is to treat the information as relevant.

For realizing one embodiment of the invention the system in accordance with this embodiment of invention should be installed in as large as possible a vehicle fleet. Provision may also be made for devices 10, 10′, . . . that work only as receivers. It is however particularly advantageous when as large as possible a number of vehicle drivers make active use of the system and operate the appropriate key 32 as soon as a route situation is to be reported that calls for greater attention by other participants. Such behavior can be promoted by appropriate measures.

The particulars contained in the above description of sample embodiments should not be construed as limitations of the scope of the invention, but rather as examples of some embodiments thereof. Accordingly, the scope of the invention should be determined not by the embodiments illustrated, but by the appended claims and their legal equivalents.

1. A device for providing route-specific information and intended for operation in a vehicle, comprising:
a location determination device for determining the present location of the vehicle,
a reception device that is equipped for receiving a plurality of information data, where the information data associate locations or location areas in each case with at least one route situation,
a processing unit that relates the plurality of information data with the determined location of the vehicle and determines the particular information data that comply with predefined relationship criteria,
an output device that, reacting to a determination of information data by the processing device, emits at least one signal,
at least one input device for entering a route situation, the input device being a keyboard with several keys, each key corresponding to one of a plurality of different route situations, and
a sending device for sending out reporting data, where the reporting data are formed by the processing unit in reaction to a signal of the input device signaling that a key has been operated, wherein the reporting data specify at least one vehicle location determined by the location determination device and the route situation indicated by the corresponding key on the keyboard.

2. A device in accordance with claim 1, wherein the location determination device comprises a GPS receiver.

3. A device in accordance with claim 1, wherein the reception device comprises a pager.

4. A device in accordance with claim 1, wherein the predefined association criteria are satisfied by information data when the vehicle location in each case agrees with the location specified by the information data or lies within the location area specified by the information data.

5. A device in accordance with claim 1, wherein the predefined association criteria are satisfied by information data when the distance between the vehicle location in each case and the location or the boundary of the location area specified by the information data amounts to not more than an amount that is predefined by the processing unit.

6. A device in accordance with claim 5, wherein the amount that is predefined by the processing unit depends on the given route situation.

7. A device in accordance with claim 5, wherein a speed determination unit is provided for determining the speed of the vehicle, and wherein the processing device predetermines the distance as a function of the determined vehicle speed.

8. A device in accordance with claim 5, wherein a navigation system is provided in which the roads are stored, and wherein the processing device predetermines the distance as a function of the road on which the vehicle is travelling.

9. A device in accordance with claim 1, wherein the information data in each case contain also time information that specifies at least one of a validity duration and an expiry time of the validity of the information data.

10. A device in accordance with claim 1, wherein the processing device is provided with a memory for storing the received information data.

11. A device in accordance with claim 1, wherein the signal emitted by the output device is at least one of an acoustic signal and an optical signal and a signal for controlling a unit of the vehicle and a signal that depends on the type of the route situation specified in the information data.

12. A device in accordance with claim 1, wherein there is provided at least one sensor for entering a route situation.

13. A device in accordance with claim 1, wherein the sending device is provided with a mobile telephone device.

14. A traffic information system with at least one system processing unit that is equipped for receiving reporting data from at least one first device for providing route-specific information, converting the reporting data into information data, passing the information data for transmission to a plurality of devices for providing route-specific information, each device for providing route-specific information operating in a vehicle and comprising:
a location determination device for determining the present location of the vehicle,
a reception device that is equipped for receiving a plurality of information data, where the information data associate locations or location areas in each case with at least one route situation,
a processing unit that relates the plurality of information data with the determined location of the vehicle and determines the particular information data that comply with predefined relationship criteria,
an output device that, reacting to a determination of information data by the processing device, emits at least one signal,
at least one input device for entering a route situation, the input device being a keyboard with several keys, each key corresponding to one of a plurality of different route situations, and
a sending device for sending out reporting data, where the reporting data are formed by the processing unit in reaction to a signal of the input device signaling that a key has been operated, wherein the reporting data specify at least one vehicle location determined by the location determination device and the route situation indicated by the corresponding key on the keyboard.

15. A traffic information system in accordance with claim 14, wherein the system processing unit is equipped for associating several incoming reporting data with each other in order to suppress erroneous reports.

16. A traffic information system in accordance with claim 14, wherein there is provided at least one system sending unit that receives information data from the system processing unit and is equipped for transmitting the received information data to the plurality of devices for providing route-specific information.

17. A method for providing route-specific information in a vehicle, comprising:
receiving a plurality of information data in the vehicle that in each case associate at least one route situation with locations or location areas,
determining the present location of the vehicle is in the vehicle,
relating the plurality of information data, in each case, to the present location of the vehicle and determining information data that comply with predefined association criteria, and
emitting at least one signal i reaction to a determination of information data that comply with the predefined association criteria, wherein
the information data originate at least partly from at least one central station that, in its turn, receives reporting data from participating vehicles, the reporting data of a participating vehicle specifying at least one location of the participating vehicle and a route situation that has been manually indicated by a driver of the participating vehicle.

18. A method in accordance with claim 17, wherein the at least one central station further receives reporting data from at least one station in a fixed position.

19. A method in accordance with claim 17, wherein reporting data received by the at least one central station are associated with each other in order to prevent the sending out of incorrect information data.
